(19) United States
(12) Patent Application Publication
(10) Pub. No.: US 2007/0108842 A1
(43) Pub. Date: May 17, 2007

(54) Apparatus and method for transient protection and synchronization of a plurality of power rails for a system on a chip

(76) Inventors: Thanh T. Tran, Houston, TX (US); Carlos E. Cisneros, Sugar Land, TX (US); Andrew E. Soukup, Missouri City, TX (US)

Correspondence Address: TEXAS INSTRUMENTS INCORPORATED, P O BOX 655474, M/S 3999, DALLAS, TX, 75265, US

(21) Appl. No.: 11/272,890

(22) Filed: Nov. 14, 2005

(51) Int. Cl. H02J 1/00

(52) U.S. Cl. 307/82

(57) ABSTRACT

In order to protect two inter-connected circuits, each powered by different power rail, a circuit is placed between the power supply and the associated power rail. The circuits for both rails are coupled. In this manner, potentially component-damaging power transients are prevented from reaching the power rails. In addition, the power rails are prevented from being separately activated. The extension of the present circuit to more than two power rails is described.

### BACKGROUND OF THE INVENTION

1. Field of the Invention

This invention relates generally to integrated circuits and, more particularly, to the conductors (or rails) supplying power to an integrated circuit.

2. Background of the Invention

As miniaturization of semiconductor elements and the density of components have increased, more than one power supply conductor or power rail has been necessary to provide power to different sets of elements. For example, an OMAP circuit can require one power rail for the OMAP CORE and another power rail for the OMAP I/O (input/output) circuits. Notwithstanding the need for two power supply voltages, the circuit elements are interconnected and therefore the voltage for a first portion of the circuit can result in damage to the second portion. Furthermore, the transients themselves can be a problem. When, as happens during testing, an already-activated power terminal (sometimes referred to as a “hot” connection) coupled to the supply rails, the resulting transient voltage can damage the components.

A need has therefore been felt for apparatus and an associated method having the feature of providing protection for interconnected circuits powered by separate power voltages. It would be yet another feature of the apparatus and associated method to prevent circuit element damage when an already-activated power line is coupled to a circuit power rail. It would be yet another feature of the apparatus and associated method to prevent the separate application of power to one of a plurality of circuits having interconnected elements. It would be yet a further feature of the apparatus and associated method to prevent the separate application of power to each of a multiplicity of circuits, the circuits having interconnected elements.

### SUMMARY OF THE INVENTION

The foregoing and other features are accomplished, according the present invention, by providing a transistor between the power supply and the power rail providing a separate voltage to each of a plurality of circuits. The control terminals of the transistors are inter-connected such that the two transistors can not be activated independently. In addition, the components of the circuits associated with each transistor reduce the transient voltages resulting from a full voltage application to the power rail.

Other features and advantages of present invention will be more clearly understood upon reading of the following description and the accompanying drawings and the claims.

### BRIEF DESCRIPTION OF THE DRAWINGS

FIG. 1 is a circuit diagram for protecting the circuits coupled to two power rails according to the present invention.

FIG. 2 is a circuit diagram for protecting the circuits coupled to three power rails according to the present invention.

### 1. DETAILED DESCRIPTION OF THE FIGURES

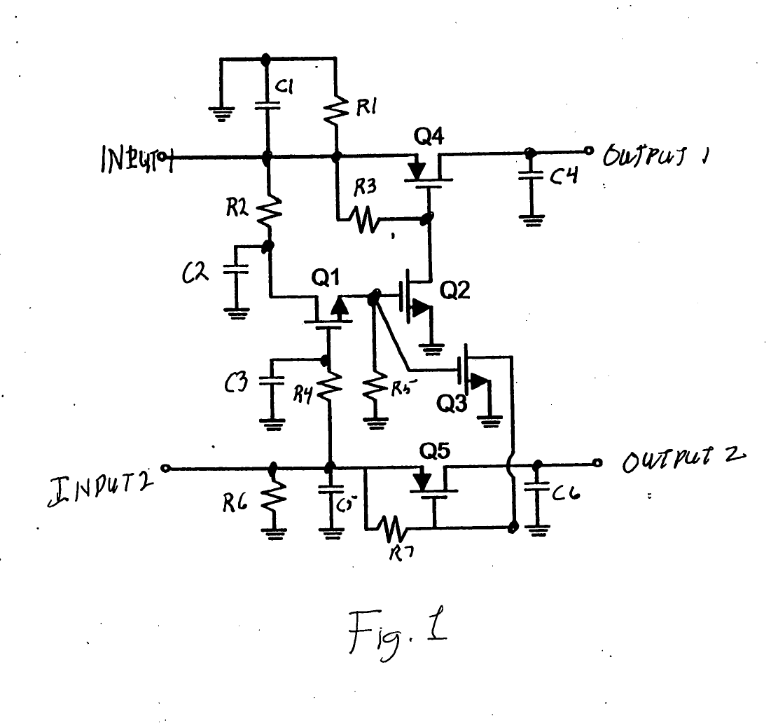

Referring to FIG. 1, an input terminal of a first power rail, INPUT 1, is coupled through capacitor C1 to ground, through resistor R1 to ground potential, to a source terminal of p-channel field effect transistor Q4, to a first terminal of resistor R2, and to a first terminal of resistor R3. The second terminal of resistor R3 is coupled to a gate terminal of transistor Q4 and to a drain terminal of n-channel, field effect transistor Q2. The drain terminal of transistor Q4 is coupled through capacitor C4 to ground and is coupled to the output terminal of the first power rail, OUTPUT 1. The second terminal of resistor R2 is coupled through capacitor C2 to ground and to the source terminal of n-channel field effect transistor Q1. The drain terminal of transistor Q1 is coupled to the gate terminal of transistor Q2, through resistor R5 to ground, and to the gate terminal of n-channel field effect transistor Q3. The gate terminal of transistor Q1 is coupled through capacitor C3 to ground and through resistor R4 to the second input terminal INPUT 22. The source terminals of transistors Q2 and Q3 are coupled to ground. The source terminal of p-channel field effect transistor Q5 is coupled to the second input terminal INPUT 2, through resistor R6 to ground, through capacitor C5 to ground and through resistor R7 to the gate terminal of transistor Q5 and the drain terminal of transistor Q3. The drain terminal of transistor Q5 is coupled through capacitor C6 to ground and is coupled to the second output terminal OUTPUT 2.

In one implementation, the resistors have a value of 10 Ohms, the capacitors have a value of 0.01 μFarads, transistors Q1, Q2, and Q3 are 2N7000 transistors, and transistors Q4 and Q5 are Si191DH transistors. It will be clear that other components and other component values can be used to implement the invention.

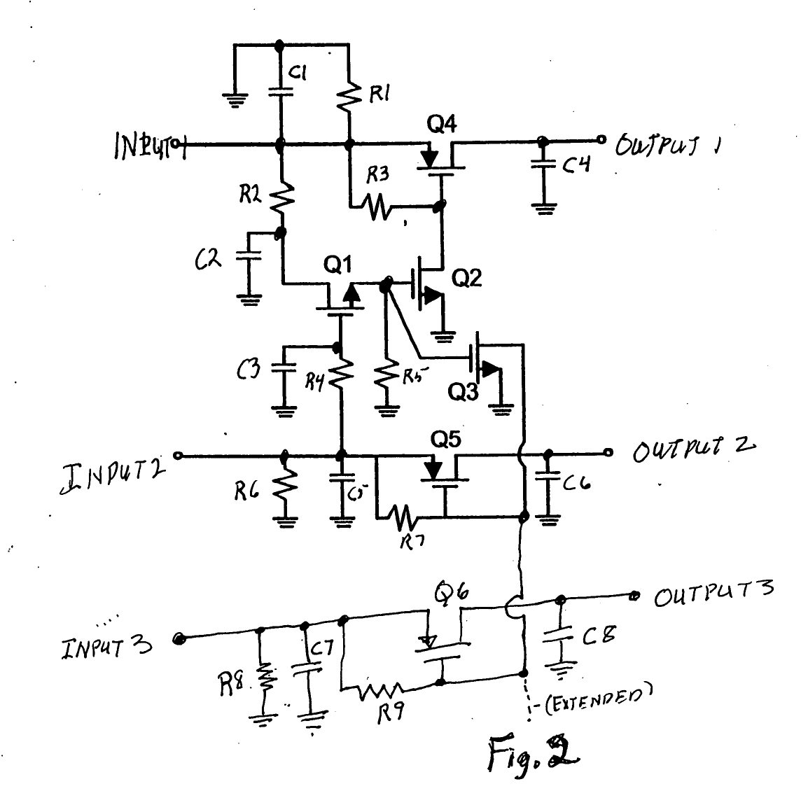

Referring to FIG. 2 the extension of the circuit shown in FIG. 1 to three power rails is illustrated. In addition to the components of FIG. 2, the third input terminal, INPUT 3, is coupled through resistor R8 to ground, through capacitor C7 to ground, to a first terminal of resistor R9, and to the source terminal of p-channel, field effect transistor Q6. The second terminal of resistor R9 is coupled to gate terminal of transistor Q6 and to the drain terminal of Q3. The drain terminal of transistor Q6 is coupled through capacitor C8 to ground and the output terminal OUTPUT 3. The dotted line marked EXTENDED and coupled to the second terminal of resistor R9, to the gate terminal of transistor Q6, and to the drain terminal of Q3 indicated the extension to the protection of additional power rails.

In the preferred embodiment, the components have the same values and identification numbers as the components of FIG. 1.

### 2. OPERATION OF THE PREFERRED EMBODIMENT

In the modern integrated circuit technology, a plurality of circuits having differing power requirements can be inter-connected, e.g., a system on a chip (SOC). For example, in a system on a chip the core circuit, the I/O circuit, and the memory circuit can each require different voltage values, i.e., processing core can require 1.2 volt supply, an associated I/O circuit can require a 3.3 volt supply and a memory can require a 1.8 volt supply. However, these circuits are not independent, but the voltage in one circuit can affect the voltage applied to components in different circuits. In the present invention, a transistor is coupled between the power supply and the chip power rail for each circuit. The control terminals are interconnected in such a manner as to prevent separate activation of the power rails (i.e., the output terminals). In addition, the inter-connection of the control (gate) terminals prevents transients being applied to the output terminals. The present circuit is particularly valuable when an active power supply terminal is applied directly to a system on a chip, such as in the testing of the chip.

While the invention has been described with respect to the embodiments set forth above, the invention is not necessarily limited to these embodiments. Accordingly, other embodiments, variations, and improvements not described herein are not necessarily excluded from the scope of the invention, the scope of the invention being defined by the following claims.

What is claimed is:

1. A circuit for coupling a plurality of power supplies energizing a plurality of power rails, the circuit comprising:
a first transistor for coupling a first power supply and a first power rail;
a second transistor for coupling a second power supply and second power rail;
a third transistor coupled to the input terminals of the first transistor and the second transistor;
a fourth transistor coupled to the third transistor, the fourth transistor coupled to the control terminal of the first transistor; and
a fifth transistor coupled to the third transistor, the fifth transistor coupled to the control terminal of the second transistor, wherein the activation of the output terminals of the first and second transistors is synchronized.

2. The circuit as recited in claim 1 wherein the power rails energize a system on a chip.

3. The circuit as recited in claim 1 wherein an activated one of the first and second power supplies can be coupled to an associated power rail input terminal without damaging components coupled to the power rail associated with the activated power supply.

4. The circuit as recited in claim 1 wherein a multiplicity of activated power supplies can each be coupled to an associated power rail input terminal without damaging components coupled to the power rail associated with the activated power supply.

5. The circuit as recited in claim 1 wherein an already activated power supply can be coupled to the associated power rail without damaging components coupled to the associated power rail.

6. A method of protecting a plurality of circuits powered by separate power rails, each power rail being activated by an associated power supply, the method comprising:
coupling a transistor between each power supply and the associated power rail; and
permitting conduction through the transistors when each of the plurality of power supplies is coupled to the associated transistor.

7. The method as recited in claim 6 further comprising activating the coupled power supplies before each coupled power rail is energized.

8. The method as recited in claim 6 further comprising coupling an interface transistor between each power supply and the power rail.

9. The method as recited in claim 6 wherein a multiplicity of power supplies are each coupled to an associated power rail.

10. The method as recited in claim 6 further comprising energizing a system on a chip by the power rails.

11. An interface unit between a plurality of power supplies and a plurality of circuits, each circuit being associated with the power supply, the interface unit comprising:
a plurality of transistors;
an input terminal coupled to each transistor, the input terminal capable of being coupled to a power supply;
an output terminal coupled to each transistor, the output terminal coupled to a circuit associated with the power supply coupled to the transistor input terminal;
a control circuit coupled to the control terminals of the transistors, the control terminal coupling the input and the output terminals of all the transistors when all of the transistors have energized power supplies coupled thereto.

12. The interface unit as recited in claim 11 wherein the plurality of circuits are portions of a system on a chip.

13. The interface unit as recited in claim 11 wherein the interface unit includes a multiplicity of transistors coupling a multiplicity of power supplies with a multiplicity of circuits.

14. The interface unit as recited in claim 11 wherein the input terminals of the transistors are monitored by transistor components.
